(19) United States
(12) Patent Application Publication
(10) Pub. No.: US 2005/0259141 A1
(43) Pub. Date: Nov. 24, 2005

(54) Method of compensating for paper slip in a thermal printer

(75) Inventors: Hyoung-il Kim, Suwon-si (KR); Kyung-pyo Kang, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/108,829

(22) Filed: Apr. 19, 2005

(30) Foreign Application Priority Data
May 19, 2004 (KR) 10-2004-0035527

(51) Int. Cl. B41J 2/32

(52) U.S. Cl. 347/197

(57) ABSTRACT

A method of compensating for paper slip in a thermal printer is provided. The method includes picking up a sheet of print paper on which first and second marks are formed and separated a predetermined distance from each other in a printing direction and feeding the sheet of print paper to a print path. The first and second marks are detected while feeding the sheet of print paper to the print path and calculating a paper slip distance on a first side of the sheet of print paper facing a thermal printhead. The thermal printhead is rotated to face a second side of the sheet of print paper. The sheet of paper is fed to the print path. The first and second marks are detected while feeding the sheet of print paper to the print path and calculating a paper slip distance on the second side.

### CROSS REFERENCE TO RELATED APPLICATION

This application claims the benefit under 35 U.S.C. § 119(a) of Korean Patent Application No. 10-2004-0035527, filed on May 19, 2004, in the Korean Intellectual Property Office, the entire disclosure of which is hereby incorporated by reference.

### BACKGROUND OF THE INVENTION

1. Field of the Invention

The present invention relates to a method of compensating for paper slip in a thermal printer. More particularly, the present invention relates to a method of compensating for paper slip in a thermal printer using double-sided heat reactive paper.

2. Description of the Related Art

A thermal printer may use a sheet of special paper (hereinafter, called heat reactive paper) that reacts to heat to display a predetermined color. Alternatively, the thermal printer may use an ink ribbon that reacts to heat and transfers a predetermined color on a sheet of ordinary paper. When the ink ribbon is used, a device for driving the ink ribbon must be installed in the thermal printer. Accordingly, the structure of the thermal printer becomes complicated and manufacturing costs of the thermal printer increase. Moreover, since the ink ribbon is consumable, the ink ribbon must be continuously replaced. Thus, printing costs per sheet of paper are high.

Referring to FIG. 1, a sheet of heat reactive paper 10 includes a base sheet 11 and ink layers 12 and 13 of a predetermined color formed on both sides, that is, first and second sides, of the base sheet 11. Each of the ink layers 12 and 13 may have a single-layer structure for representing a single color or a multi-layer structure for representing two or more colors. For example, the ink layer 12 on the first side of the base sheet 11 may have a structure in which two layers for representing magenta (M) and cyan (C) are stacked, and the ink layer 13 on the second side of the base sheet 11 may have a single-layer structure for representing yellow (Y). The base sheet 11 may be made of a transparent material. An example of the heat reactive paper 10 is disclosed in U.S. Patent Publication No. 2003/0125206.

A thermal printer, which uses the heat reactive paper 10, uses a thermal printhead (TPH) including electrothermal devices disposed at a predetermined resolution perpendicularly to a paper moving direction. In the case of double-sided printing using one TPH, printing is performed on the first side of the sheet of heat reactive paper 10. Then, printing is performed again on the second side of the sheet of heat reactive paper 10 using the TPH. After the printing is performed on both sides of the heat reactive paper 10, a complete color image is seen from one side of the heat reactive paper 10.

FIG. 2 illustrates a configuration of a conventional thermal printer. Referring to FIG. 2, the conventional thermal printer includes a feeding roller 2 moving a sheet of heat reactive paper 1, a platen roller 3 supporting one side of the sheet of heat reactive paper 1, and a TPH 4 forming an image on the sheet of heat reactive paper on the platen roller 3. An idle roller 5 presses the sheet of heat reactive paper 1, which is passed between the idle roller 5 and the feeding roller 2, toward the feeding roller 2.

When an image is formed on the sheet of heat reactive paper 1, the sheet of heat reactive paper 1 is held between the TPH 4 and the platen roller 3, thereby reducing a driving force of the feeding roller 2. In other words, as the sheet of heat reactive paper 1 slips, a feeding distance may be changed. Such paper slip may deteriorate the quality of an image printed by the thermal printer.

Accordingly, a need exists for an improved thermal printer that compensates for paper slip.

### SUMMARY OF THE INVENTION

The present invention provides a method of compensating for paper slip of heat reactive paper in a thermal printer.

According to an aspect of the present invention, a method of compensating for paper slip in a thermal printer includes picking up a sheet of print paper on which first and second marks are formed and separated a predetermined distance from each other in a printing direction and feeding the sheet of print paper to a print path. The first and second marks are detected while feeding the sheet of print paper to the print path and calculating a paper slip distance on a first side of the sheet of print paper facing a thermal printhead. The thermal printhead is rotated to face a second side of the sheet of print paper. The sheet of paper is fed to the print path. The first and second marks are detected while feeding the sheet of print paper to the print path and calculating a paper slip distance on the second side.

The steps of detecting the first and second marks may be performed by at least one optical sensor a predetermined height separated from the sheet of print paper.

The sheet of print paper may include a trim region at a front portion and a print region in a printing direction. The first and second marks may be formed at the print region.

According to another aspect of the present invention, a method is provided to compensate for paper slip in a thermal printer. The method includes picking up a sheet of print paper and feeding the sheet of print paper to a print path. First and second marks are formed to be separated a predetermined distance from each other on a first side of the sheet of print paper in a printing direction while feeding the sheet of print paper. The first and second marks are detected while feeding the sheet of print paper to the print path and calculating a paper slip distance on the first side of the sheet of print paper facing a thermal printhead. The thermal printhead is rotated to face a second side of the sheet of print paper. The first and second marks are detected while feeding the sheet of print paper to the print path and calculating a paper slip distance on the second side.

The steps of detecting the first and second marks and calculating paper slip on the first side may include measuring a distance between the first and second marks where a paper slip distance is included. The step of detecting first and second marks and calculating paper slip on the second side may be measuring an actual distance between the first and second marks.

According to another aspect of the present invention, a method of compensating for paper slip in a thermal printer is provided. The method includes picking up a sheet of print paper on which first and second marks are formed separated a predetermined distance from each other in a printing direction and feeding the sheet of print paper to a print path. The first and second marks are detected while feeding the sheet of print paper to the print path. A paper slip distance of the sheet of print paper is calculated.

The sheet of print paper may include a trim region on a front portion and a print region in the printing direction. The first and second marks may be formed in the trim region. The step of calculating paper slip may further include printing print data in the printing direction in consideration of the paper slip distance of the sheet of print paper.

Other objects, advantages and salient features of the invention will become apparent from the following detailed description, which taken in conjunction with the annexed drawings, discloses preferred embodiments of the invention.

### BRIEF DESCRIPTION OF THE DRAWINGS

The above and other features and advantages of the present invention will become more apparent by describing in detail exemplary embodiments thereof with reference to the attached drawings, in which:

FIG. 1 is a sectional view of conventional heat reactive paper;

FIG. 2 illustrates a configuration of a conventional thermal printer;

FIG. 3 illustrates a thermal printer using a method of compensating for paper slip according to an exemplary embodiment the present invention;

FIG. 4 is a schematic top view of a portion of the thermal printer using a method of compensating for paper slip according to an exemplary embodiment of the present invention;

FIG. 5 is a schematic side view of a portion of FIG. 4;

FIG. 6 illustrates a sheet of heat reactive paper used in the method of compensating for paper slip according to an exemplary embodiment of the present invention;

FIG. 7 is a flowchart illustrating a method of compensating for paper slip in a thermal printer according to a first exemplary embodiment of the present invention;

FIGS. 8A and 8B are drawings illustrating the method of FIG. 7;

FIG. 9 is a flowchart illustrating a method of compensating for paper slip in a thermal printer according to a second exemplary embodiment of the present invention; and

FIG. 10 is a flowchart illustrating a method of compensating for paper slip distance in a thermal printer according to a third embodiment of the present invention.

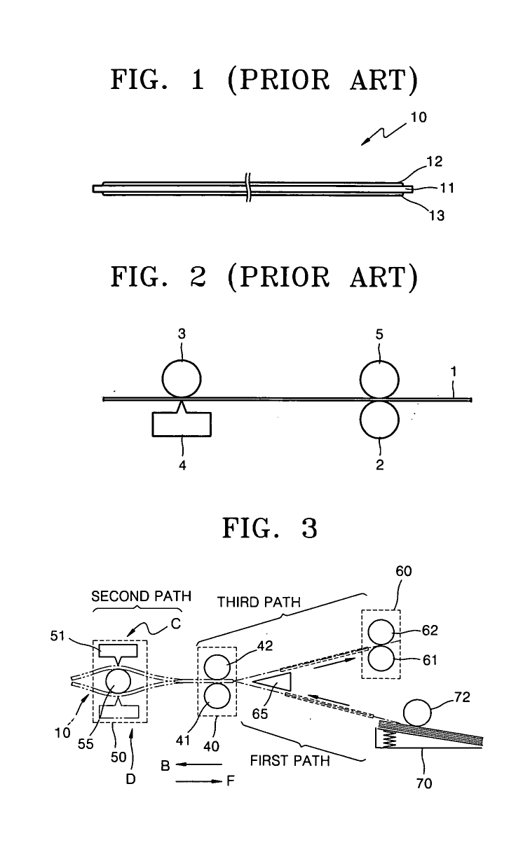

Throughout the drawings, like reference numerals will be understood to refer to like parts, components and structures.

### DETAILED DESCRIPTION OF EXEMPLARY EMBODIMENTS

Embodiments of the present invention will now be described more fully with reference to the accompanying drawings. The invention may, however, be embodied in many different forms and should not be construed as being limited to the exemplary embodiments set forth therein; rather, these exemplary embodiments are provided for a thorough and complete disclosure, and will fully convey the concept of the invention to those skilled in the art.

FIG. 3 illustrates a thermal printer using a method of compensating for paper slip according to an exemplary embodiment of the present invention. Referring to FIG. 3, the thermal printer has first, second and third paths, through which a sheet of heat reactive paper 10 is moved. The first path is a paper feed path through which the sheet of heat reactive paper 10 is fed to the second path. The second path is where the sheet of heat reactive paper 10 is fed backward in a direction indicated by an arrow B and fed forward in a direction indicated by an arrow F to print an image on the sheet of heat reactive paper 10.

The third path is where the sheet of heat reactive paper 10, on which an image is being printed, is disposed. When the image is printed only on a first side of the sheet of heat reactive paper 10, the sheet of heat reactive paper 10 is fed back to the second path from the third path. When the image is printed on the first and second sides of the sheet of heat reactive paper 10, the sheet of heat reactive paper 10 is discharged through the third path.

A paper guide 65 is disposed between the first path and the third path. The paper guide 65 guides the sheet of heat reactive paper 10 fed through the first path to the second path and also guides the sheet of heat reactive paper 10 from the second path to the third path. The paper guide 65 guides the sheet of heat reactive paper 10 fed through the second path only to the third path and prevents the sheet of heat reactive paper 10 to proceed to the first path. Also, the paper guide 65 guides the sheet of heat reactive paper 10 fed through the first path only to the second path. Since the structure and design of the paper guide 65 are well-known, they will not be further described.

An image forming unit 50 forms an image at the second path. Such an image forming process may be required twice or more times. In an exemplary embodiment of the present invention, the image forming process is performed twice, that is, once on each of the first and second sides of the sheet of heat reactive paper 10. Before the image forming unit 50 forms an image on the first and second sides of the sheet of heat reactive paper 10, a thermal printhead (TPH) 51 and a platen roller 55 included in the image forming unit 50 must be held at predetermined positions. For example, when an image is formed on the first side of the sheet of heat reactive paper 10, the TPH 51 must be positioned at a location “C”. When the image is formed on the second side of the sheet of heat reactive paper 10, the TPH 51 must be positioned at a location “D”.

The position of the TPH 51 may be changed as the platen roller 55 and the TPH 51 are rotated with respect to a rotation axis of the platen roller 55. The position of the TPH 51 is changed when there is no interference with the sheet of heat reactive paper, for example, before the sheet of heat reactive paper 10 is fed from the first path, or when the sheet of heat reactive paper 10 is not fed back to the second path from the third path where an image is formed on the first side of the sheet of heat reactive paper 10.

When the sheet of heat reactive paper 10 having an image formed on the first side thereof is fed back to the second path, forming an image on the second side of the sheet of heat reactive paper 10 is performed by the TPH 51, which position is already rotated. In this process, a conveying unit 40 gradually conveys the sheet of heat reactive paper 10. After the image is formed on the second side of the sheet of heat reactive paper 10, the sheet of heat reactive paper 10 proceeds further in the second path and is discharged from the thermal printer through a paper discharge unit 60.

The conveying unit 40 includes a feeding roller 41 feeding the sheet of heat reactive paper 10 and an idle roller 42 pressing the sheet of heat reactive paper 10, which passes between the feeding roller 41 and the idle roller 42, toward the feeding roller 41. Reference numeral 70 indicates a paper cassette and reference numeral 72 indicates a pickup roller for supplying sheets of paper.

The paper discharge unit 60 includes a discharge roller 61 and an idle roller 62. The discharge roller 61 and the pickup roller 72 may be integrated into a single roller performing the functions of the discharge roller 61 and the pickup roller 72.

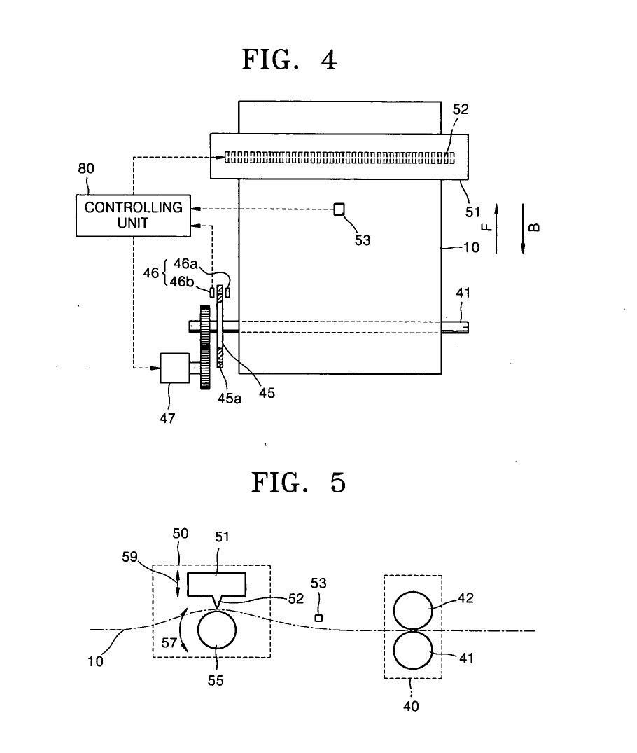

FIG. 4 is a schematic top view of a portion of the thermal printer using a method of compensating for paper slip according to an exemplary embodiment of the present invention. FIG. 5 is a schematic side view of a portion of the apparatus of FIG. 4.

Referring to FIGS. 4 and 5, the sheet of heat reactive paper 10 passed between the platen roller 55 and the TPH 51 is controlled by the feeding roller 41. Reference numeral 53 indicates a sensor detecting marks on the sheet of heat reactive paper 10. An optical sensor may be used as the sensor 53.

The sheet of heat reactive paper 10 is fed backward in a direction indicated by an arrow B and fed forward in a direction (printing direction) indicated by an arrow F. An encoder disk wheel 45 is mounted on an outer circumference of one side of the feeding roller 41. Slits 45a are formed at the edge of the encoder disk wheel 45 and spaced at regular intervals. A rotary encoder sensor 46 includes a light source 46a and a light receiving unit 46b, which are mounted on both sides of the slit 45a.

The light source 46a of the rotary encoder sensor 46 emits light at regular speed and the light receiving unit 46b generates a pulse signal whenever light is received through the slit 45a. A controlling unit 80 measures a distance that the sheet of heat reactive paper 10 is moved by the feeding roller 41 by counting a number of pulse signals. The controlling unit 80 also controls a driving motor 47 to control the distance that the sheet of heat reactive paper 10 is moved by the feeding roller 41.

A duplex printing apparatus includes a rotation unit 57 and a unit for vertical movement 59. The rotation unit 57 rotates the TPH 51 and the platen roller 55 to print an image on the second side of the sheet of heat reactive paper 10 after an image is printed on the first side of the sheet of heat reactive paper 10. The unit for vertical movement 59 moves the TPH 51 a predetermined distance away from or closer to the printing path. When the sheet of heat reactive paper 10 is fed back, the unit for vertical movement 59 is used to separate the TPH 51 a predetermined distance, for example 1-2 mm, away from the platen roller 55 such that the sheet of heat reactive paper 10 may be easily passed between the TPH 51 and the platen roller 55.

Table 1 shows a result of measuring a paper slip distance when an image is printed on the sheet of heat reactive paper 10 using the duplex printing apparatus of FIG. 4.

TABLE 1

| | Actual Distance/Target | |
|---|---|---|
| Printed Side | DSistance | Paper Slip Distance (mm) |
| First side | 0.99742 | 3.81 |
| Second side | 0.97501 | 0.39 |

Here, the first side denotes an upper side of the sheet of heat reactive paper 10 and the second side denotes that an image was printed on a lower side of the sheet of heat reactive paper 10. The measurement indicates data obtained by averaging five measurements. The paper slip distance was obtained by converting a length of a print region of the sheet of heat reactive paper 10 into 6 inches.

Referring to Table 1, when printing is performed on the sheet of heat reactive paper 10 between the TPH 51 and the platen roller 55, the actual distance that the sheet of heat reactive paper 10 is moved by the feeding roller 41 is shorter than a target distance. The paper slip distance of the sheet of heat reactive paper 10 may be changed according to the state of the feeding roller 41, the positions of the TPH 51 and the platen roller 55, and the used duration of the TPH 51 and the platen roller 55.

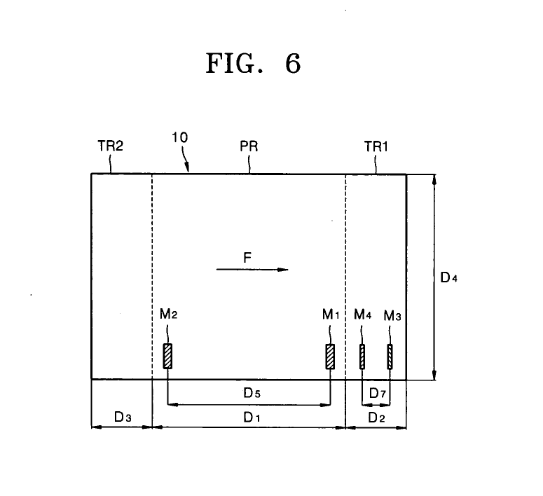

FIG. 6 illustrates a sheet of heat reactive paper 10 used in the method of compensating for paper slip according to an exemplary embodiment of the present invention. Referring to FIG. 6, the sheet of heat reactive paper 10 is divided into a print region PR, and first and second trim regions TR1 and TR2 that are trimmed after printing is completed. A length D1 of the print region PR is preferably six inches and a length D4 of the print region PR is preferably four inches. A length D2 of the first trim region TR1 is preferably roughly one inch, and a length D3 of the second trim region TR2 is preferably one third inch. A direction indicated by an arrow F is a direction in which the sheet of heat reactive paper 10 is fed forward for printing. Reference numerals M1 through M4, D5, and D7 will be described later.

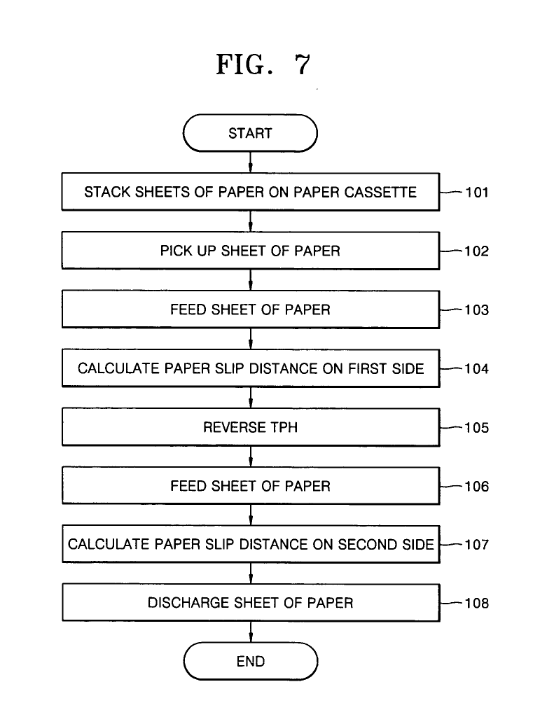

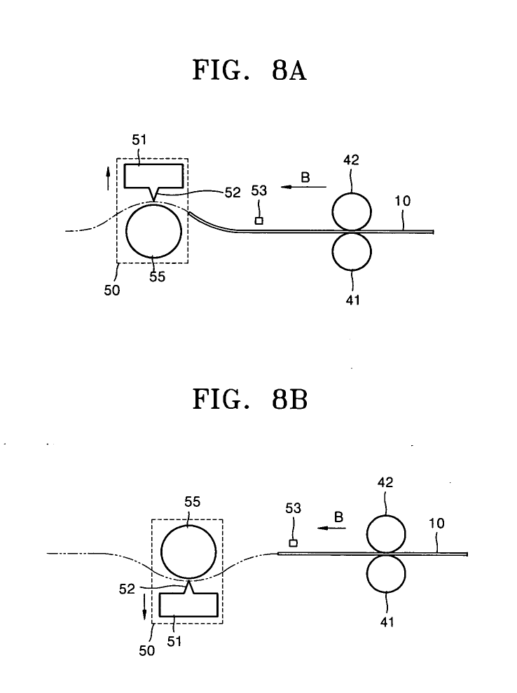

A method of compensating for paper slip in a thermal printer according to an exemplary embodiment of the present invention will now be described with reference to the drawings. FIG. 7 is a flowchart illustrating a method of compensating for paper slip in a thermal printer according to a first exemplary embodiment of the present invention. FIGS. 8A and 8B are drawings explaining the method of FIG. 7.

Sheets of heat reactive paper 10 to be tested are stacked on the paper cassette 70 (operation 101). First and second marks M1 and M2 may be printed in advance a predetermined distance (D5 of FIG. 6) away from each other in a paper moving direction on the print region PR of a sheet of the heat reactive paper 10.

When a command to measure a paper slip distance of a sheet of heat reactive paper 10 is input from the thermal printer or a computer device connected to the thermal printer to the controlling unit 80, the pickup roller 72 picks up a sheet of heat reactive paper 10 and moves the sheet of heat reactive paper 10 to the first path (operation 102).

The sheet of heat reactive paper 10 that enters the first path is guided to the feeding roller 41 by the paper guide 65 and the feeding roller 41 feeds the sheet of heat reactive paper 10 back to the second path as illustrated in FIG. 8A (operation 103). Here, the TPH 51 may be separated a predetermined height from the platen roller 55 by using the unit of vertical movement 59 (FIG. 5). The sheet of heat reactive paper 10 that enters the second path may be fed back such that the entire print region PR of the sheet of heat reactive paper 10 may be printed. To this end, the rotary encoder sensor 46 detects the rotation of the rotary encoder wheel 45 installed on the circumference of the feeding roller 41 and generates a pulse signal. When the rotary encoder sensor 46 transmits the generated pulse signal to the controlling unit 80, the controlling unit 80 counts the pulse signal and measures the distance that the sheet of heat reactive paper 10 is fed back.

Then, the TPH 51 is lowered to press against the back-fed sheet of heat reactive paper 10. The sheet of heat reactive paper 10 is fed forward as the feeding roller 41 is rotated in reverse. At this time, the optical sensor 53 detects the first mark M1 formed on the first side (the upper side in the drawing) of the sheet of heat reactive paper 10. After detecting the first mark M1, the optical sensor 53 outputs a detection signal to the controlling unit 80. In this case, the rotary encoder sensor 46 outputs a position where the first mark M1 was detected to the controlling unit 80.

When the sheet of heat reactive paper 10 is continuously fed forward, the optical sensor 53 detects the second mark M2 and the rotary encoder sensor 46 outputs a position of the second mark M2 to the controlling unit 80.

The controlling unit 80 calculates the distance D6 between the first mark M1 and the second mark M2, which is a driving distance of the feeding roller 41, and compares the distance D6 with the actual distance D5. Based on the comparison, the controlling unit calculates a paper slip distance (S1) and a paper slip rate (SR1) using Equation 1 (operation 104).
Paper slip distance (S1)=D6−D5
Paper slip rate (SR1)=S1/D5 [Equation 1]

The sheet of heat reactive paper 10 is fed forward a predetermined distance further such that the sheet of heat reactive paper 10 does not contact the image forming unit 50 when the image forming unit 50 rotates. The image forming unit 50 is rotated and, accordingly, the position of the TPH 51 is reversed such that the TPH 51 faces the second side of the sheet of heat reactive paper 10 (operation 105). FIG. 8B illustrates the TPH 51 whose position is reversed.

The TPH 51 is slightly lowered to form a gap between the upper platen roller 55 and the TPH 51 such that the sheet of heat reactive paper 10 may be passed through the gap without resistance. Then, the sheet of heat reactive paper 10 is fed back by the conveying unit 40 to the second path in preparation for forming an image on the second side of the sheet of heat reactive paper 10 (operation 106).

The process of making sure that the sheet of heat reactive paper 10 is fed back to such an extent that the entire print region is fed back is identical to operation 103 described above. Thus, a detailed description of the process is omitted.

Next, the TPH 51 is raised to press against the back-fed sheet of heat reactive paper 10. While the feeding roller 41 feeds the sheet of heat reactive paper 10 forward, the distance between the first and second marks M1 and M2, which were already printed on the sheet of heat reactive paper 10 is measured by the optical sensor 53. Then, the paper slip distance and the paper slip rate on the second side of the sheet of heat reactive paper 10 are calculated (operation 107). Since operation 107 is identical to operation 104, a detailed description of operation 107 is omitted.

The sheet of heat reactive paper 10 is moved to the third path. The conveying unit stops moving the sheet of heat reactive paper 10. Instead, the sheet of heat reactive paper 10 is continuously moved and discharged out of the thermal printer by the paper discharge unit 60 (operation 108).

In the exemplary embodiments of the present embodiment, the method of measuring the paper slip distance is described with reference to a thermal printer that prints successively first and second sides of a sheet of heat reactive paper. However, the present invention is not limited to such an apparatus. In other words, the method may be applied to a thermal printer that simultaneously prints first and second sides of a sheet of heat reactive paper using two TPHs. In this case, the process of rotating the TPH, specifically, operations 105 and 106, are omitted and operations 104 and 107 may be performed simultaneously. The paper slip distances on the first and second sides may be detected at the same time.

Meanwhile, marks may be holes. Thus, holes on the first and second sides may be detected by an optical sensor facing one side of the sheet of heat reactive paper. In addition, since the heat reactive paper is preferably transparent, marks at the sheet of heat reactive paper may be used to determine paper slip distances on the first and second sides.

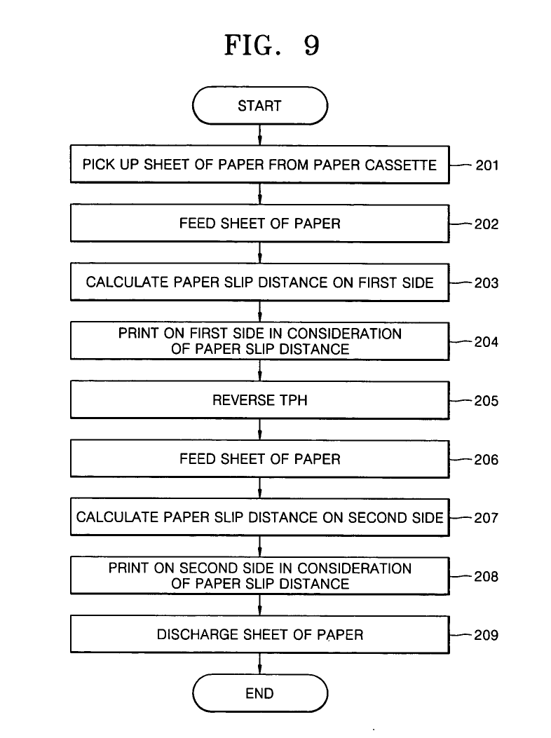

FIG. 9 is a flowchart illustrating a method of compensating for paper slip in a thermal printer according to a second exemplary embodiment of the present invention. Unlike in the first exemplary embodiment, marks are formed in the first trim region TR1 in the second exemplary embodiment of the present invention.

When a print command is input from the thermal printer or a computer device connected to the thermal printer to the controlling unit 80, the pickup roller 72 picks up a sheet of heat reactive paper 10 from the paper cassette 70 and moves the sheet of heat reactive paper 10 to the first path (operation 201). Third and fourth marks M3 and M4 may be printed in advance a predetermined distance (D7 of FIG. 6) away from each other in the paper moving direction on the first trim region TR1 of the sheet of the heat reactive paper 10.

The sheet of heat reactive paper 10 that enters the first path is guided to the feeding roller 41 by the paper guide 65 and the feeding roller 41 feeds the sheet of heat reactive paper 10 back to the second path as illustrated in FIG. 8A (operation 202). Here, the TPH 51 may be separated a predetermined height from the platen roller 55. The sheet of heat reactive paper 10 that enters the second path may be fed back such that the third mark M3 may be detected by the optical sensor 53 during the printing process. The rotary encoder sensor 46 detects the rotation of the rotary encoder wheel 45 installed on the circumference of the feeding roller 41 and generates a pulse signal. When the rotary encoder sensor 46 transmits the generated pulse signal to the controlling unit 80, the controlling unit 80 counts the pulse signal and measures the distance that the sheet of heat reactive paper 10 is fed back.

Then, the TPH 51 is lowered to press against the back-fed sheet of heat reactive paper 10. The sheet of heat reactive paper 10 is fed forward as the feeding roller 41 is rotated in reverse. At this time, the optical sensor 53 detects the third mark M3 formed on the first side (the upper side in the drawing) of the sheet of heat reactive paper 10. After detecting the third mark M3, the optical sensor 53 outputs a detection signal to the controlling unit 80. The rotary encoder sensor 46 outputs a position where the third mark M3 was detected to the controlling unit 80.

When the sheet of heat reactive paper 10 is continuously fed forward, the optical sensor 53 detects the fourth mark M4 and the rotary encoder sensor 46 outputs a position of the fourth mark M2 to the controlling unit 80.

The controlling unit 80 calculates the distance D8 between the third mark M3 and the fourth mark M4, which is the driving distance of the feeding roller 41, and compares the distance D8 with the actual distance D7. Based on the result of the comparison, the controlling unit 80 calculates a paper slip distance (S2) and a paper slip rate (SR2) using Equation 2 (operation 203).
Paper slip distance (S2)=D8−D7
Paper slip rate (SR2)=S2/D7 [Equation 2]

Print data input from an external source is printed on the first side in consideration of the paper slip distance (S2) on the first side of the sheet of heat reactive paper 10 (operation 204).

The sheet of heat reactive paper 10 is fed forward a predetermined distance further such that the sheet of heat reactive paper 10 does not contact the image forming unit 50 when the image forming unit 50 rotates.

The image forming unit 50 is rotated and, accordingly, the position of the TPH 51 is reversed such that the TPH 51 faces the second side of the sheet of heat reactive paper 10 (operation 205). FIG. 8B illustrates the TPH 51 whose position is reversed.

The TPH 51 is slightly lowered to form a gap between the upper platen roller 55 and the TPH 51 such that the sheet of heat reactive paper 10 may be passed through the gap without resistance. Then, the sheet of heat reactive paper 10 is fed back by the conveying unit 40 to the second path in preparation for forming an image on the second side of the sheet of heat reactive paper 10 (operation 206).

The process of feeding the sheet of heat reactive paper 10 back is identical to operation 202 described above. Thus, a detailed description of the process is omitted.

Next, the TPH 51 is raised to press against the back-fed sheet of heat reactive paper 10. While the feeding roller 41 feeds the sheet of heat reactive paper 10 forward, the distance between the third and fourth marks M3 and M4, which were already printed on the first trim region TR1 of the sheet of heat reactive paper 10 is measured by the optical sensor 53. Then, the paper slip distance and the paper slip rate on the second side of the sheet of heat reactive paper 10 are calculated (operation 207). Since operation 207 is identical to operation 204 in which the first side of the sheet of heat reactive paper 10 is measured, a detailed description of operation 207 is omitted.

The sheet of heat reactive paper 10 is moved to the third path. The third and fourth marks M3 and M4 used for the first side of the sheet of heat reactive paper 10 may also be used for the second side. Print data input from an external source is printed on the second side in consideration of the paper slip distance (S2) on the second side of the sheet of heat reactive paper 10 (operation 208). An imaginary length obtained by multiplying a length of the print data in a printing direction by a correction ratio (D7/D8) is printed.

The conveying unit 40 stops moving the sheet of heat reactive paper 10. Instead, the sheet of heat reactive paper 10 is continuously moved and discharged out of the thermal printer by the paper discharge unit 60 (operation 209).

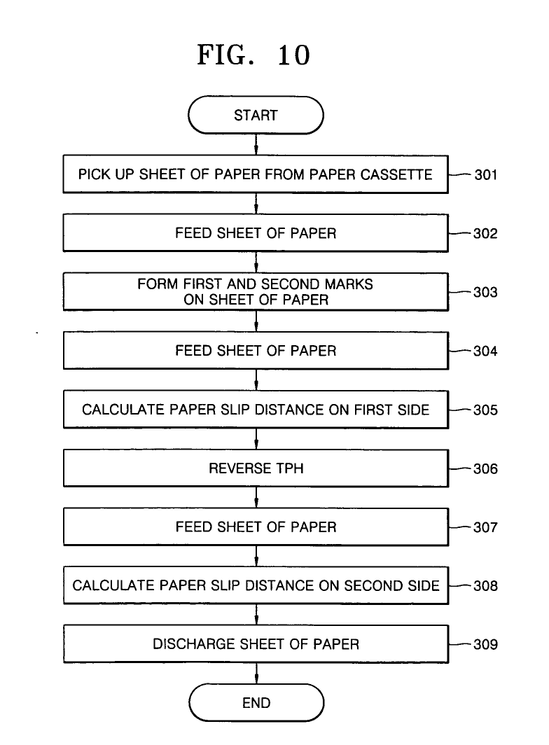

FIG. 10 is a flowchart illustrating a method of measuring and correcting a paper slip distance in a thermal printer according to a third exemplary embodiment of the present invention. The third exemplary embodiment includes an operation of forming the first and second marks M1 and M2 of FIG. 6.

When a print command is input from the thermal printer or a computer device connected to the thermal printer to the controlling unit 80, the pickup roller 72 picks up a sheet of heat reactive paper 10 from the paper cassette 70 and moves the sheet of heat reactive paper 10 to the first path (operation 301). The sheet of heat reactive paper 10 that enters the first path is supplied to the feeding roller 41 by the paper guide 65 and the feeding roller 41 feeds the sheet of heat reactive paper 10 back to the second path as illustrated in FIG. 8A (operation 302). Here, the TPH 51 may be separated a predetermined height from the platen roller 55.

Then, the TPH 51 is lowered to press against the sheet of heat reactive paper 10. The sheet of heat reactive paper 10 is fed forward as the feeding roller 41 is rotated in reverse. In this process, the first and second marks M1 and M2 are formed on the sheet of heat reactive paper 10 (operation 303). The distance between the first and second marks M1 and M2 is calculated by a driving distance of the feeding roller and stored as a first distance (D9). The first distance (D9) indicates a distance travelled by the sheet of heat reactive paper 10 when the sheet of heat reactive paper 10 is in contact with the TPH 51.

The sheet of heat reactive paper 10 is fed back again such that the first mark M1 on the sheet of heat reactive paper 10 goes through the optical sensor 53 (operation 304).

As the sheet of heat reactive paper 10 is fed forward again, the optical sensor 53 sequentially detects the first and second marks M1 and M2 formed on the first side of the sheet of heat reactive paper 10. The TPH 51 is kept separated a predetermined height from the sheet of heat reactive paper 10.

The controlling unit 80 calculates a second distance D10 between the first mark M1 and the second mark M2 based on a driving distance of the feeding roller 41. The second distance D10 corresponds to an actual distance between the first and second marks M1 and M2. The controlling unit 80 compares the second distance D10 with the first distance D9 in operation 303 and, based on the result of the comparison, calculates a paper slip distance (S3) and a paper slip rate (SR3) using Equation 3 (operation 305).
Paper slip distance (S3)=D9−D10
Paper slip rate (SR3)=S3/D10 [Equation 3]

The sheet of heat reactive paper 10 is fed forward a predetermined distance further such that the sheet of heat reactive paper 10 does not contact the image forming unit 50 when the image forming unit 50 rotates.

When the first and second marks M1 and M2 are printed on the first trim region TR1, the paper slip distance (S3) on the first side of the sheet of heat reactive paper 10 is measured. Print data input from an external source may be successively printed on the print region PR of the first side in consideration of the paper slip distance (S3) on the first side of the sheet of heat reactive paper 10. An imaginary length obtained by multiplying a length of the print data in the printing direction by a correction ratio (D10/D9) is printed.

The image forming unit 50 is rotated and, accordingly, the position of the TPH 51 is reversed such that the TPH 51 faces the second side of the sheet of heat reactive paper 10 (operation 306).

The TPH 51 is slightly lowered to form a gap between the upper platen roller 55 and the TPH 51 such that the sheet of heat reactive paper 10 may be passed through the gap without resistance. Then, the sheet of heat reactive paper 10 is fed back to the second path such that the first mark M1 on the sheet of heat reactive paper 10 goes through the optical sensor 53 (operation 307).

Next, the TPH 51 is raised to press against the back-fed sheet of heat reactive paper 10. While the feeding roller 41 feeds the sheet of heat reactive paper 10 forward, the distance between the first and second marks M1 and M2 is measured. Then, the paper slip distance and the paper slip rate on the second side of the sheet of heat reactive paper 10 are calculated (operation 308). Since operation 308 is identical to operation 305, a detailed description of operation 308 is omitted.

When the first and second marks M1 and M2 are printed on the first trim region TR1, the paper slip distance (S3) on the second side of the sheet of heat reactive paper 10 is measured. Print data input from an external source may be successively printed on the print region PR of the second side in consideration of the paper slip distance (S3) on the second side of the sheet of heat reactive paper 10. An imaginary length obtained by multiplying a length of the print data in the printing direction by a correction ratio (D10/D9) is printed.

The conveying unit 40 stops moving the sheet of heat reactive paper 10. Instead, the sheet of heat reactive paper 10 is continuously moved and discharged out of the thermal printer by the paper discharge unit 60 (operation 309).

According to a method of compensating for paper slip in a thermal printer described above, a thermal printer using heat reactive paper may easily measure a paper slip distance of a sheet of heat reactive paper. If a print length in a printing direction is corrected in consideration of the paper slip distance when printing is performed on a corresponding side of the sheet of heat reactive paper, an image with desired quality may be obtained.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of compensating for paper slip in a thermal printer, comprising the steps of
(a) picking up a sheet of print paper on which first and second marks are formed that are separated a predetermined distance from each other in a printing direction and feeding the sheet of print paper to a print path;
(b) detecting the first and second marks while feeding the sheet of print paper to the print path and calculating a paper slip distance on a first side of the sheet of print paper facing a thermal printhead;
(c) rotating the thermal printhead to face a second side of the sheet of print paper;
(d) feeding the sheet of paper to the print path; and
(e) detecting the first and second marks while feeding the sheet of print paper to the print path and calculating a paper slip distance on the second side.

2. The method of claim 1, further comprising
performing the steps (b) and (e) with at least one optical sensor disposed a predetermined height from the sheet of print paper.

3. The method of claim 1, further comprising
forming the first and second marks in a print region of the sheet of print paper, a trim region being disposed at a front portion and a print region being disposed in the printing direction.

4. The method of claim 1, further comprising
forming the first and second marks in a trim region of the sheet of print paper, the trim region being disposed at a front portion and a print region being disposed in the printing direction.

5. The method of claim 4, wherein
the step (b) further comprises printing print data of the first side in the printing direction in consideration of the paper slip distance on the first side.

6. The method of claim 5, wherein
the step (e) further comprises printing print data of the second side in the printing direction in consideration of the paper slip distance on the second side.

7. The method of claim 1, further comprising
forming the first and second marks at a trim region and a print region, respectively, the sheet of print paper having a trim region at a front portion and a print region in the printing direction.

8. A method of compensating for paper slip in a thermal printer, comprising the steps of
(a) picking up a sheet of print paper and feeding the sheet of print paper to a print path;
(b) forming first and second marks that are separated a predetermined distance from each other on a first side of the sheet of print paper in a printing direction while feeding the sheet of print paper;
(c) detecting the first and second marks while feeding the sheet of print paper to the print path and calculating a paper slip distance on the first side of the sheet of print paper facing a thermal printhead;
(d) rotating the thermal printhead to face a second side of the sheet of print paper; and
(e) detecting the first and second marks while feeding the sheet of print paper to the print path and calculating a paper slip distance on the second side.

9. The method of claim 8, wherein
the steps (b) and (e) further comprise measuring a distance between the first and second marks where a paper slip distance is included.

10. The method of claim 8, wherein
the step (c) further comprises measuring an actual distance between the first and second marks.

11. The method of claim 8, further comprising
performing the steps (b) and (e) with at least one optical sensor a predetermined height separated from the sheet of print paper.

12. The method of claim 8, further comprising
forming the first and second marks in a print region of the sheet of print paper having a trim region at a front portion and the print region in the printing direction.

13. The method of claim 8, further comprising
forming the first and second marks in a trim region of the sheet of print paper having the trim region at the front portion and a print region in the printing direction.

14. The method of claim 13, wherein
the step (c) further comprises printing print data of the first side in the printing direction in consideration of the paper slip distance on the first side.

15. The method of claim 14, wherein
the step (e) further comprises printing print data of the second side in the paper moving direction in consideration of the paper slip distance on the second side.

16. The method of claim 8, further comprising
forming the first and second marks at the a trim region and a print region, respectively, of the sheet of print paper having the trim region at a front portion and the print region in the printing direction.

17. A method of compensating for paper slip in a thermal printer, comprising the steps of
(a) picking up a sheet of print paper on which first and second marks are formed that are separated a predetermined distance from each other in a printing direction and feeding the sheet of print paper to a print path;
(b) detecting the first and second marks while feeding the sheet of print paper to the print path; and
(c) calculating a paper slip distance of the sheet of print paper.

18. The method of claim 16, further comprising
forming the first and second marks in a trim region of the sheet of print paper having the trim region at a front portion and a print region in the printing direction.

19. The method of claim 18, wherein
the step (c) further comprises printing print data in the printing direction in consideration of the paper slip distance of the sheet of print paper.
